(19) United States
(12) Patent Application Publication
(10) Pub. No.: US 2018/0290091 A1
(43) Pub. Date: Oct. 11, 2018

(54) Securing System and Method for Assembling or Disassembling the Securing System

(71) Applicant: NETZSCH Trockenmahltechnik GmbH, Selb (DE)

(72) Inventors: Frank Winter, Mühlheim (DE); Karlheinz Terlecki, Singen (DE)

(21) Appl. No.: 15/751,799

(22) PCT Filed: Jul. 29, 2016
(86) PCT No.: PCT/DE2016/000296

§ 371 Date: Jun. 5, 2018

(30) Foreign Application Priority Data
Aug. 10, 2015 (DE) 10 2015 113 127.7

(51) Int. Cl. B01D 46/00; B01D 46/06

(52) U.S. Cl. CPC B01D 46/0005; B01D 2265/028; B01D 46/06

(57) ABSTRACT

A fastening system for filter bags and baskets. The filter bag with a first outer diameter for filtering dust particles and a filter basket for the internal stabilization and fastening of the filter bag. A connecting region arranged on a perforated filter plate for connecting the filter bag and/or the filter basket to the filter installation. The connecting region includes a cutout for the filter bag. The filter bag includes at one end at least one snap ring for the connection to the connecting region, and has a second outer diameter in the region of the snap ring. The filter basket includes at its upper end at least two spring elements for connection to the connecting region. The snap ring is elastically deformable and can be brought into at least a first shape, the cross-sectional area whereof is smaller than an area of the inner cross-section of the cutout of the perforated filter plate.

### TECHNICAL FIELD

The present invention relates to a fastening system and a method for the assembly and dismantling of the fastening system according to the features of the invention.

### BACKGROUND

Fastening systems for filter bags and filter baskets on filter installations are already known. A known system for fitting filter bags on bag filter installations permits fitting and removal of the filter bags upwards over the clean gas chamber of the filter installation (top removal system). The advantage with this fastening system is a fastening of the filter bags by means of a so-called snap-ring system. The filter bags are fixed to the filter installation by means of a snap ring, in such a way that very good sealing effects are achieved and low residual dust contents can be measured in the ambient air. Since the top removal system permits straightforward fitting and removal without a special fitting tool, fitting errors can be eliminated. Although good filter results can be achieved with the aid of a top removal system, it is however a drawback with this kind of fastening of filter bags that a freedom of movement of minimum size of the filter bags and filter baskets has to be made available when the filter bags and/or filter baskets are replaced, since a removal of the filter bags and/or filter baskets has to be carried out above the filter installation. Additional room height may be required, which often cannot be made available on account the building situation.

In the case of a room height that is too small, however, recourse has to be taken to a system which permits fitting and removal of the filter bags and/or filter baskets via the raw gas chamber of the filter installation (side removal system), since the filter bags and/or filter baskets can be fitted from the side of the filter installation at the underside of a perforated plate. Considerable time has to be spent on fitting, however, for the fitting or removal of the filter bags and/or filter baskets. In addition, a fitting tool is required. According to experience, known side removal systems are often highly susceptible to fitting errors.

Thus, a side removal device for fastening filter bags and/or filter baskets is known, which permits fixing of the filter bags with the aid of a bead system. Here, the filter bag must first be pulled over a filter basket. At the upper end, the filter bag is driven inwards into the basket. A bead is arranged on a perforated filter plate. Due to the design, the filter basket springs up on the bead during the fitting and is thus clamped firmly to the perforated filter plate. The system must be secured to the bead with the aid, for example, of a clip. A Venturi tube is fitted on the side of the perforated filter plate facing away from the bag. The utmost care must be taken when fitting the filter bag or the filter basket in order to ensure tightness to the clean gas chamber.

Furthermore, side removal screwing systems are used. With this mode of procedure, the filter bags are also pulled over the filter baskets and folded over. The filter basket is fitted in a pressed part with a bead fitted externally and is secured with a clip. This fitting can take place outside the filter. A thread is present in the interior of the pressed part. A matching counter-thread is provided beneath a perforated filter plate, to which the filter basket or the filter bag can be fixed. In order to ensure tightness of the clean gas chamber, an O-ring is inserted between the threaded portion and the perforated filter plate. A drawback with this system, however, is that the different sealing faces to the clean gas chamber result, i.e. between the filter bag and the bead located on the pressed part and respectively at the O-ring arranged between the pressed part and the perforated filter plate. Each sealing face presents a potential risk of dust blow-out. In addition, the threaded connection can easily work loose, as a result of which dust blow-out occurs. On account of the high load on the threaded connection, cracks and leaks can occur. Furthermore, the fitting procedure has to be carried out with a great deal of care in order to ensure a dust-tight connection system.

A device is known from DE 203 05 310 U1, which comprises a wire basket comprising elongated wires. The elongated wires are held together with the aid of wire rings or partial wire rings, in such a way that the wire basket acquires a compressible upper part. The filter bag comprises a connecting region to a perforated filter plate, which region comprises two bead rings spaced apart from one another and a steel ring. The filter bag is arranged on the connecting region in such a way that the bead rings spaced apart lie above and below the perforated filter plate. By means of the wire basket, the filter bag is fixed to the perforated filter plate and also secured by a closure clip. A drawback with this device, however, is a complex structure of the filter basket on account of the basket weave structure and the closure clip as well as a relatively complex and inflexible fitting effort via the clean gas side of the filter installation.

The problem of the invention is to provide a fastening system for filter bags and filter baskets, which enables easy and rapid fitting, a virtually complete elimination of fitting errors, a tool-free replacement of the filter bag or the filter basket and a dust-tight connection of the device to the filter installation as well as fitting and removal laterally through the raw gas chamber of the filter installation in a side removal system.

### SUMMARY

The above problem is solved by a device and a method according to the invention.

The invention relates to a fastening system, comprising a filter bag with a first outer diameter for filtering dust particles and a filter basket for the internal stabilization and fastening of the filter bag. Furthermore, the fastening system comprises a connecting region arranged on a perforated filter plate for connecting the filter bag and/or the filter basket to the filter installation. The connecting region comprises a cutout for the filter bag. Ideally, the connecting region comprises an at least approximately circular cutout for the connection of the filter bag and/or the filter basket. For the connection to the connecting region, the filter bag comprises at least one snap ring at a free end. In addition, the filter bag in the region of the snap ring has a second outer diameter, which is at least slightly larger than the first outer diameter of the filter bag. The filter basket is constituted by a basket-like structure and comprises at its upper end at least two spring elements for connection to the connecting region. The snap ring is elastically deformable and can be brought into at least a first shape, the cross-sectional area whereof is smaller than an area of the inner cross-section of the cutout of the perforated filter plate. A stable engagement surface for the introduction of force during the fitting of the filter bag can thus be made available. The fastening system is constituted such that a system for side removal assembly or side removal dismantling can be provided.

In a further embodiment, the filter bag comprises for the connection to the connecting region, at the one end which is intended for connection to the filter installation, two insertion bands spaced apart from one another. The insertion bands are elastically deformable and constituted such that, on account of the thickness of the insertion bands, in each case a thickened region with the second outer diameter of the filter bag is formed. According to the invention, the embodiment of the filter bag can ideally be of a size which is such that a direct connection face of the filter bag can be produced at the cutout of the connecting region.

In a further aspect of the invention, the filter bag is connected to the connecting region in such a way that the two insertion bands lie respectively at the surface and the underside of the perforated filter plate. The two insertion bands can be fastened to the connecting region in such a way that the filter bag cannot perform a vertical movement.

In addition, the snap ring can be arranged such that it is covered at least partially over its area at a side edge by the insertion bands, as a result of which a stable engagement surface arises to facilitate the fitting and/or removal of the filter bag. As soon as the filter bag is pressed in at least on one side in the region of the snap ring, the introduction of the filter bag into the connecting region can be carried out.

The filter basket is constituted for example as a basket-like structure with spring elements fastened thereto. The material used to produce the filter basket is ideally a metal, the use of a plastic material however also being conceivable. The filter bag is partially turned back over the filter basket for the connection to the connecting region of the perforated filter plate. The part of the filter basket that is located completely inside the filter bag is ideally constituted as a kind of wire mesh. As a result of the wire mesh, the filter bag experiences a shape-maintaining internal stabilization. For the connection to the connecting region, the filter basket comprises at the upper end of the wire mesh at least two spring elements, preferably spring clips made of steel material. The spring elements are constituted such that they can perform an elastic deformation when a pressing force occurs. The length and number of the spring elements is selected such that straightforward fitting and/or removal of the filter basket and the filter bag, inside which the filter basket is positioned, is enabled. The filter basket is thus provided with two to six, but ideally three, spring elements, so that sufficient clearance for the fitting and/or removal of the filter bag is present, a certain fastening stability of the filter basket nonetheless being maintained.

According to the invention, an introduction of the spring elements into the connecting region is enabled by means of a pressing movement against the spring elements directed in the direction of the centre-point of the spring basket, in order to provide for easy fitting and/or removal. As soon as the pressing movement ceases, the spring elements move back into their initial position on account of their spring force and lie adjacent to the connecting region, so that the spring elements can be suspended in the connecting region. The spring elements are provided with at least partially U-shaped clip ends, which are able to clamp around the upper insertion band on the surface of the perforated filter plate and lie on the surface of the connecting region. The spring elements thus partially surround the upper insertion band of the filter bag and ensure further securing and stabilization of the filter bag at the connecting region. The spring effect of the spring elements makes a further stabilization or fixing measure of the filter bag or the filter basket superfluous.

The arrangement of the filter bag at the connecting region can take place such that the perforated filter plate is located between the two insertion bands spaced apart from one another. The distance between the insertion bands is selected such that the insertion bands ideally lie with the mutually opposite lateral faces directly on the connecting region. Possible vertical movements of the filter bag are thus prevented and dust blow-out on account of a permeable sealing point is prevented. After easing of the pressing force on the snap ring, the latter springs back into its previous shape thanks to its spring force, so that the filter bag can lie adjacent to the connecting region in the desired position, in order to maintain a dust-tight sealing point between the filter bag and the perforated filter plate.

According to a preferred embodiment of the invention, one or more further snap rings can be fitted spaced apart from the first snap ring for the further stabilization of the engagement surface of the filter bag. The insertion bands can also have a different width for easier handling of the filter bag. Ideally, the filter bag, on account of its embodiment, has a stability which is such that, apart from the spring elements, no further fixing is required.

With this type of embodiment of the filter bag, a connection by means of a bead or a clip can be dispensed with. Furthermore, additional sealing between the connection of the filter bag at the connecting region is no longer necessary. The assembly of the device is facilitated on account of the simple embodiment and the time required for the assembly is shortened.

Filter installations are usually provided with a Venturi element, in particular a Venturi nozzle, in the region of the filter bag or the filter basket. In order to enable lifting-out of the filter bag in the vertical direction and guidance or centring of the filter basket in the radial direction, the Venturi element is fastened detachably, for example by means of a screw connection, to the connecting region via an integrally formed collar of a plate portion. According to the invention, a non-detachable connection of the Venturi element is conceivable, for example by means of a welded connection or a one-piece embodiment of the Venturi element and the perforated filter plate as a pressed or cast part.

As a further embodiment, recessed snap-in portions can be arranged in the circumference around the connecting region. The snap-in portions are positioned such that the clip ends of the spring elements of the filter basket can engage therein. A further securing of the fastening of the filter basket can thus be provided.

The assembly of the fastening system comprises a few simple, manually performable assembly steps. No assembly tool is required for the assembly procedure. In the first step, the filter bag is pulled up to 90% onto the basket. The spring elements of the filter basket are then subjected to pressing inwards and passed through the cutout of the connecting region. As soon as the pressing force ceases, the spring elements move back into their initial position, and the filter basket can be suspended in the connecting region. Following this, the filter bag is subjected to pressing inwards on one side in the region of the snap ring, as a result of which a deformation and a reduction in the size of the cross-section results. The snap ring thus deformed is then passed through the cutout of the connecting region. When the pressing is removed from the snap ring, the filter bag can lie adjacent to the connecting region. On account of the arrangement and embodiment of the spring elements on the filter basket, access can be gained to the snap ring without effort. For the further fixing of the filter bag or the filter basket, the Venturi element is positioned and connected on the side of the connecting region of the perforated filter plate facing away from the bag by means of a plate portion which comprises an integrally formed collar.

An assembly tool is likewise not required for the dismantling of the fastening system. The filter bag is subjected to pressing inwards on one side in the region of the snap ring, as a result of which a deformation and reduction in size of the cross-section of the filter bag results, and the latter is passed through the cutout of the connecting region out of the latter. The spring elements of the filter basket are then subjected to pressing inwards and passed through the cutout of the connecting region out of the latter. The removal of the filter bag and the filter basket can also take place simultaneously.

### BRIEF DESCRIPTION OF THE DRAWINGS

Examples of embodiment of the invention and its advantages are to be explained in greater detail below with the aid of the appended figures. The size ratios of the individual elements with respect to one another in the figures do not always correspond to the actual size ratios, since some forms are represented simplified and other forms are represented enlarged in relation to other elements for the sake of better illustration.

FIG. 1 shows a schematic view of a filter basket according to the invention.

FIG. 2 shows a further schematic view of a filter basket according to the invention.

FIG. 3 shows a schematic view of a filter bag according to the invention.

FIG. 4 shows a further schematic view of the filter bag according to the invention.

FIG. 5 shows a schematic side view of a device according to the invention.

FIG. 6a shows a first assembly step for the assembly of the fastening system.

FIG. 6b shows a second assembly step for the assembly of the fastening system.

FIG. 6c shows a third assembly step for the assembly of the fastening system.

FIG. 6d shows a fourth assembly step for the assembly of the fastening system.

FIG. 7a shows a first dismantling step for the dismantling of the fastening system.

FIG. 7b shows a second dismantling step for the dismantling of the fastening system.

FIG. 7c shows a third dismantling step for the dismantling of the fastening system.

### DETAILED DESCRIPTION

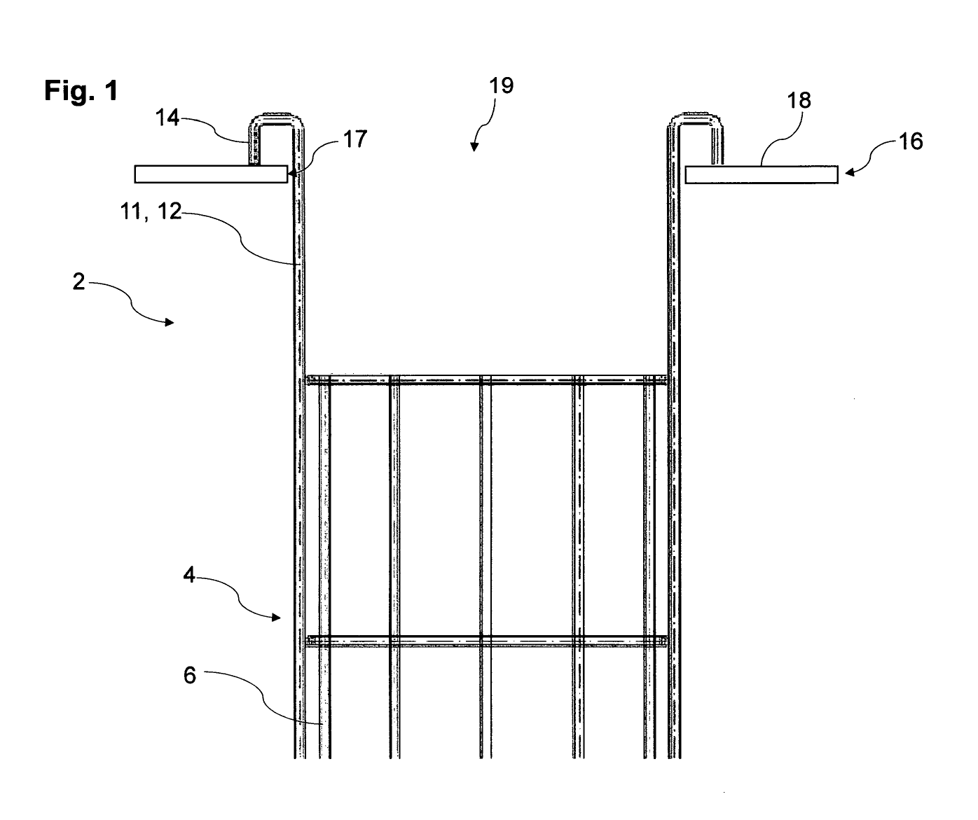

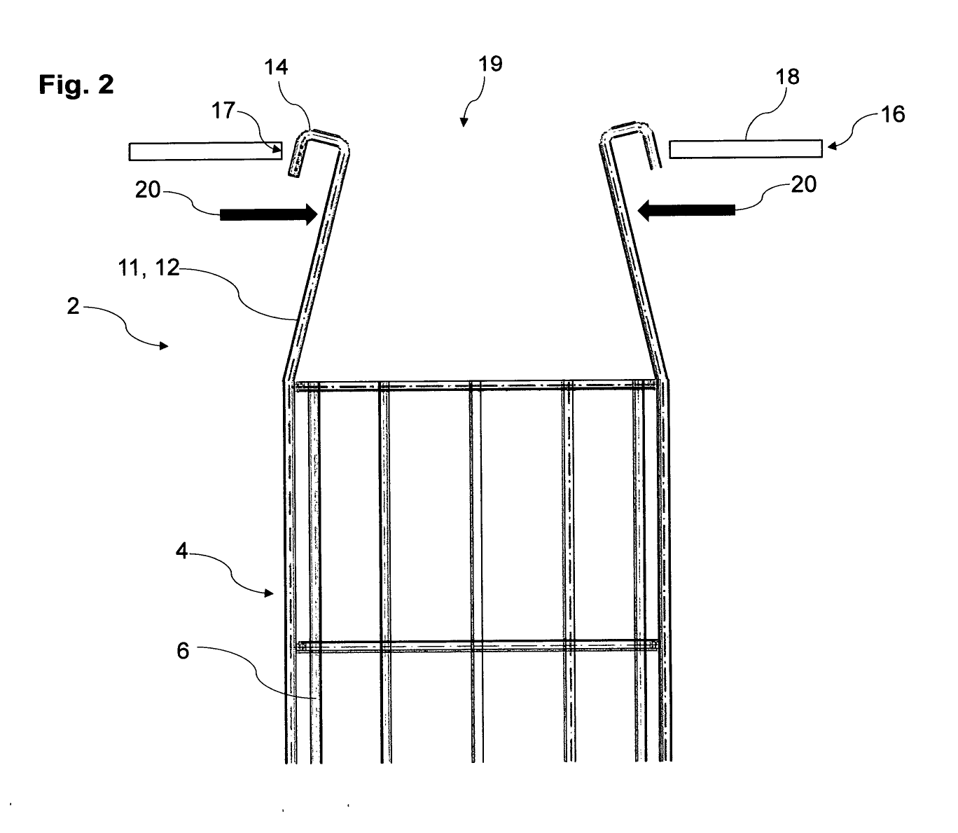

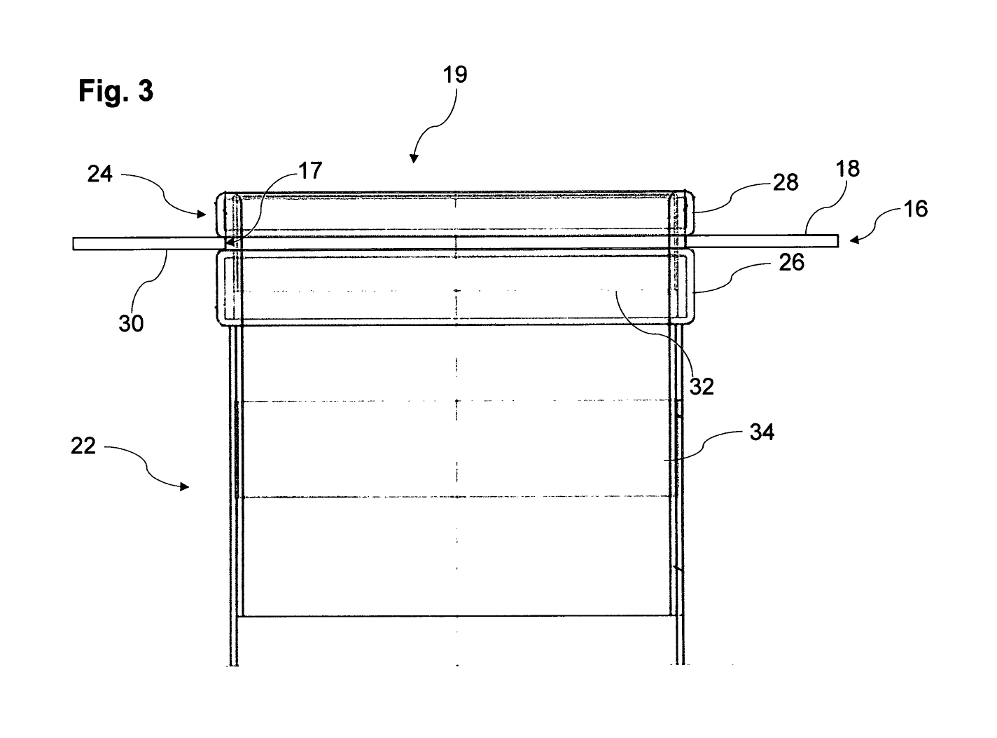

FIGS. 1 and 2 each show a schematic view of a filter basket 2 according to the invention. Filter basket 2 is ideally made of metal, production from a plastic material also being conceivable. In lower region 4, filter basket 2 comprises for example a wire mesh 6. The length or width dimension of wire mesh 6 is guided by the dimensions of filter bag 22 (not represented, see FIGS. 3 to 5), in order to stabilize and fasten the latter in the ideal manner. In the upper region of filter basket 2, two to six, but ideally three, spring elements 11 in the form of spring clips 12 are fitted onto wire mesh 6, which have elastically deformable properties. Spring clips 12 are provided with at least approximately U-shaped or curved clip ends 14. Spring clips 12 are constituted such that they can be arranged in a connecting region 17 of perforated filter plate 16. The free ends of clip ends 14 lie, after fitting of filter basket 2, on surface 18 of perforated filter plate 16. Connecting region 17 comprises an at least approximately circular cutout 19. Filter basket 2 has a size which is such that spring clips 12 lie spaced apart from the edge of cutout 19 of connecting region 17, in such a way that there is sufficient clearance for the fitting of filter bag 22 to connecting region 17.

In order to position filter basket 2 in connecting region 17, a pressing force directed approximately in the direction of the centre-point of the filter basket, symbolized with the aid of arrows 20 in FIG. 2, is required against spring clips 12. Spring clips 12 are pressed in so far that spring clips 12 can be introduced into cutout 19 of connecting region 17. As soon as pressing force 20 ceases, spring clips 12 move back into their initial position, comparable to the situation represented in FIG. 1.

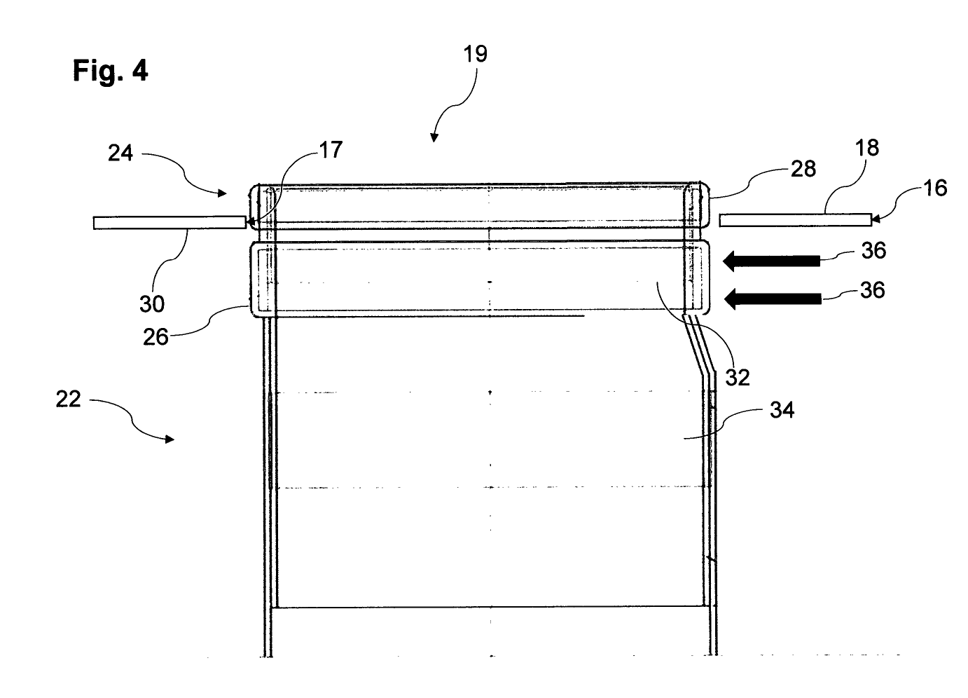

A schematic representation of a filter bag 22 according to the invention is illustrated in each case in FIGS. 3 and 4. Filter bag 22 is produced from a flexible filter material and has at upper end 24 an at least approximately circular circumference corresponding to connecting region 17 of perforated filter plate 16, said circumference having a first outer diameter. A snap ring 32 is arranged at upper free end 24 of the filter bag. Snap ring 32 can be elastically deformed by a pressing movement to carry out the fitting of filter bag 22. An expenditure of force is required for this. The diameter of snap ring 32 is selected such that filter bag 22, after the connection to connecting region 17, can lie adjacent to the inner edge of cutout 19.

In the region of upper end 24, filter bag 22 also has a second increased outer diameter. This second outer diameter, which is only slightly greater than the first outer diameter, can be produced for example by working an insertion band 28 into the filter material.

According to the example of embodiment represented, two insertion bands 26 and 28 are worked into the material of filter bag 22 at upper end 24 of filter bag 22 intended for connection to perforated filter plate 16 in order to produce the second, increased outer diameter. Insertion bands 26, 28 are spaced apart from one another to an extent such that the mutually opposite lateral faces of insertion bands 26, 28 can lie on surface 18 and underside 30 of connecting region 17. An extension of insertion bands 26 and 28 of differing width is conceivable. As a result of insertion band 26, there is a better engagement surface for fitting filter bag 22.

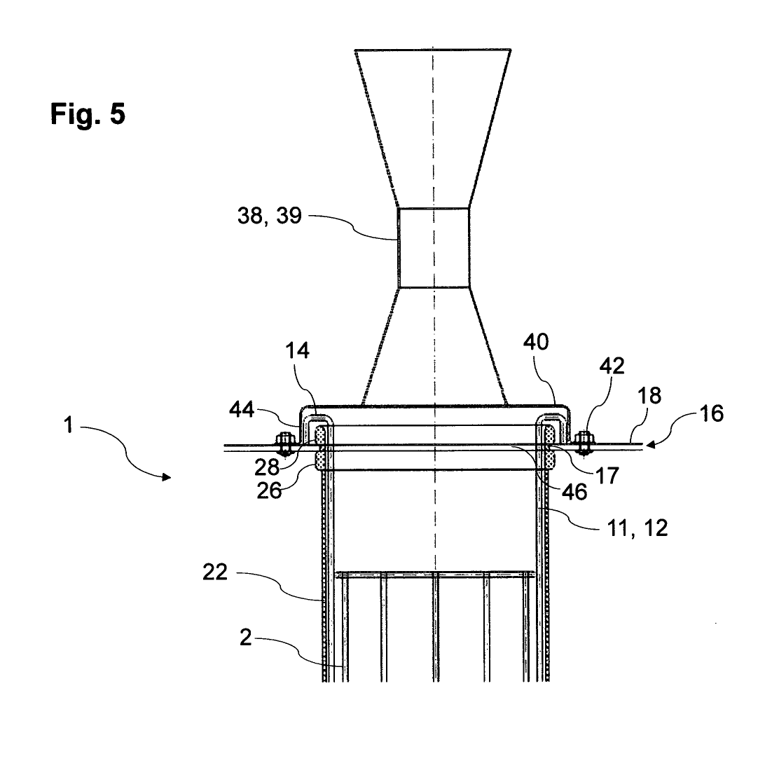

Snap ring 32 incorporated at upper end 24 of filter bag 22 is covered over the surface at least partially by the two insertion bands 26 and 28. In order to offer a better engagement surface for fitting filter bag 22, a further snap ring 34 can be arranged beneath insertion bands 26 and 28, which further snap ring also brings about stabilization of filter bag 22 in the region of spring clips 12 (not represented, see FIG. 5).

In order to fit filter bag 22 to the filter installation, which is not illustrated, upper end 24 of filter bag 22 has to be deformed, as is indicated in FIG. 4. Only a small expenditure of force is required for this, symbolized by arrows 36, in order to press in snap ring 32 and insertion bands 26, 28, so that upper end 24 of filter bag 22 can be introduced into connecting region 17. As soon as the force effect on snap ring 32 ceases, the latter again assumes its initial shape on account of its spring force. A dust-impermeable sealing face 46 is formed by the periphery of snap ring 32 and the contact faces of insertion bands 26 and 28 at cutout 19 of connecting region 17.

FIG. 5 shows a schematic representation of a fitted filter bag 22 and a fitted filter basket 2 of a fastening system 1. As a result of insertion bands 26 and 28 of filter bag 22, a dust-impermeable sealing face 46 arises between filter bag 22 and perforated filter plate 16. The fitting of filter basket 2 by means of clip ends 14 of spring clips 12 can endow sealing face 46 between filter bag 22 and connecting region 16 with additional stability.

For the ideal function of the filter installation, a Venturi element 38 in the form of a Venturi nozzle 39 is arranged at surface 18 of connecting region 17. Venturi nozzle 39 is connected to a plate portion 40, which comprises an integrally formed collar 44. Via plate collar 40, Venturi nozzle 39 is fastened to connecting region 17 by means of a detachable screw connection 42. According to the invention, however, a non-detachable connection of Venturi nozzle 39 is also conceivable, for example by a welded connection or a one-piece embodiment of Venturi nozzle 39 and perforated filter plate 16 as a pressed or cast part. Integrally formed collar 44 of plate portion 40 is constituted such that plate portion 40 can be bent over the connection of filter bag 22 or filter basket 2 to connecting region 17. This embodiment brings about an additional securing against a vertical lift-out movement of filter bag 22 or a guidance of filter basket 2 in the radial direction.

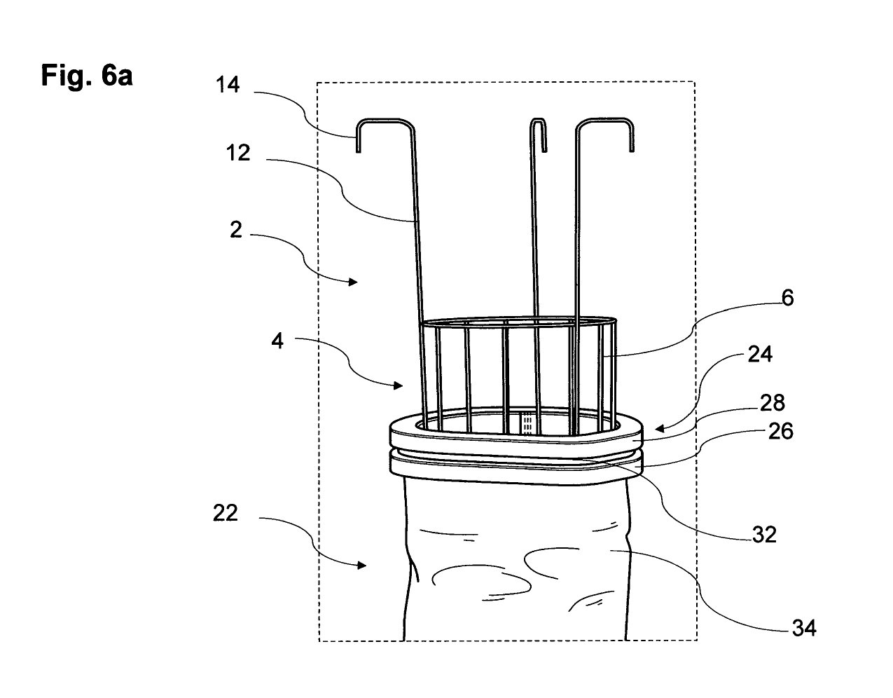

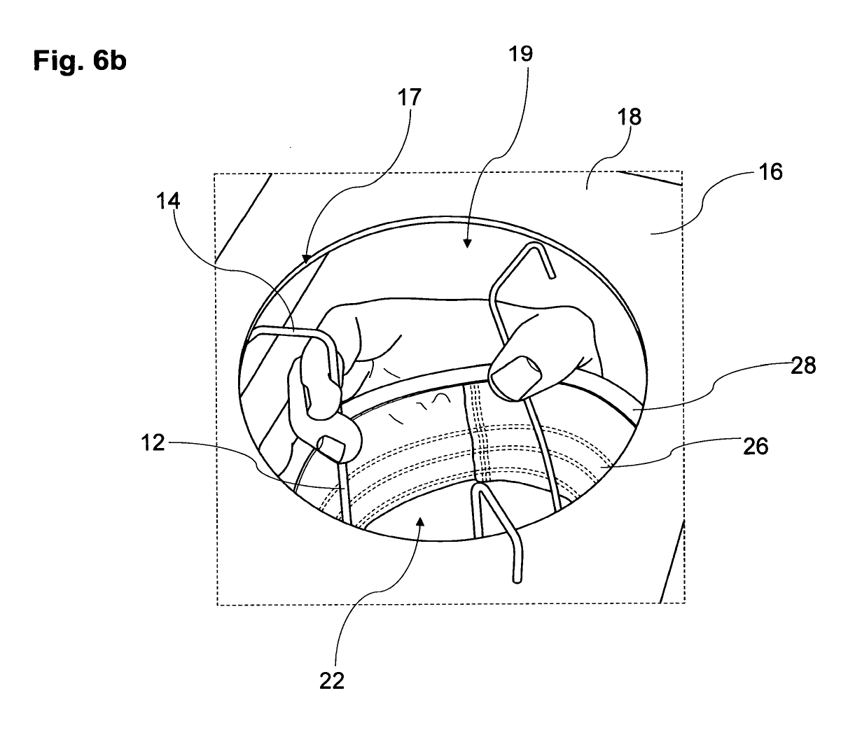

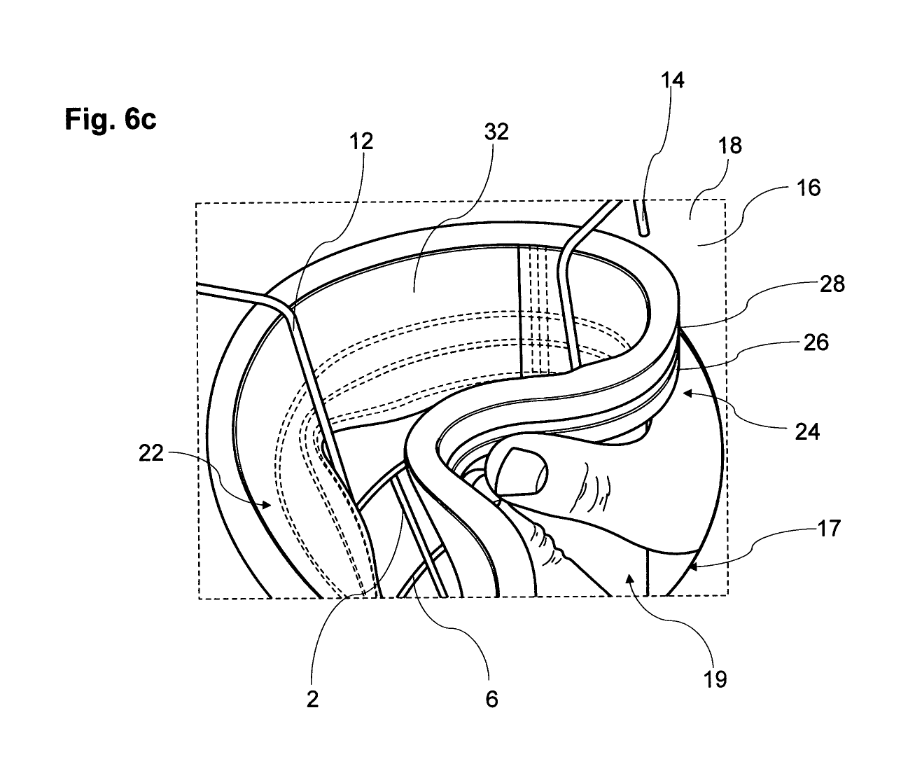

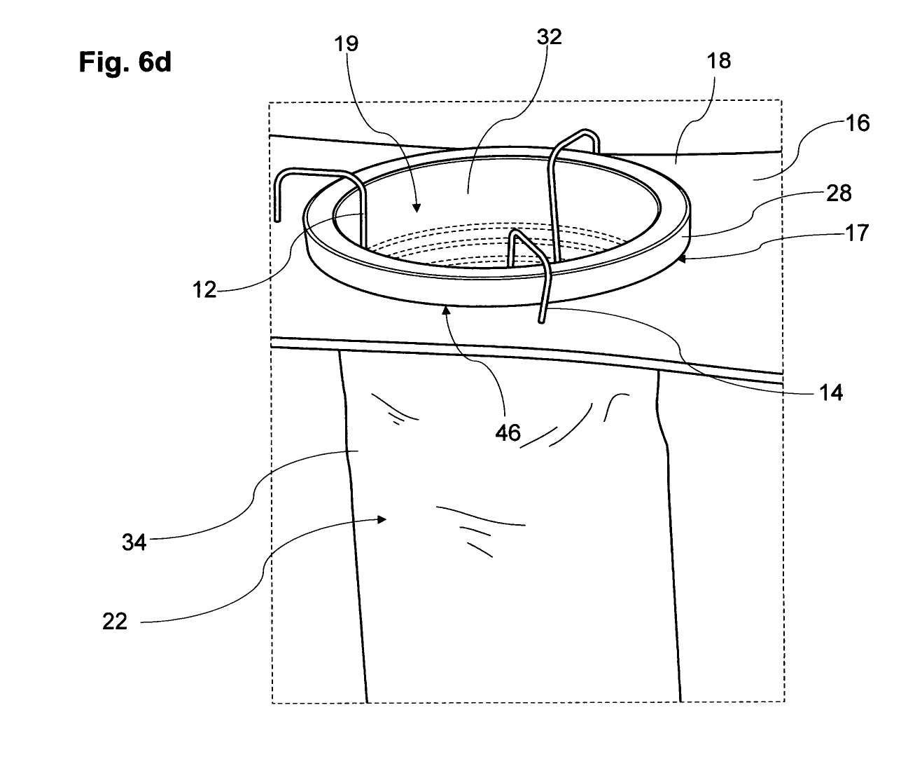

FIGS. 6a to 6d describe four assembly steps for assembling fastening system 1 according to the invention. In a first assembly step, illustrated in FIG. 6a, filter bag 22 is pulled over a filter basket 2. Filter bag 22 is pulled roughly so far over filter basket 2 that wire mesh 6 is covered by filter bag 22. A stable engagement surface on filter bag 22 is provided by means of snap ring 32 at upper end 24 of filter bag 22 in interaction with insertion bands 26 and 28 as well as second snap ring 34. FIG. 6b shows a second assembly step. A pressing force directed inwards is exerted against spring clips 12, so that the latter can be introduced into connecting region 17. Spring clips 12 move back into their initial position after removal of the pressing force on account of their spring force and lie with clip ends 14 on surface 18 of perforated filter plate 16. Filter bag 22 is still roughly in the same position into which it was brought during the first assembly step. The fitting of filter bag 22 to connecting region 17 takes place in the third assembly step, illustrated in FIG. 6c. Upper end 24 of filter bag 22 is deformed in the region of snap ring 32 in such a way that its cross-section is smaller than the area of the inner cross-section of cutout 19 of connecting region 17. On account of the distribution of spring clips 12 on filter basket 2, access can easily gained to upper end 24 of filter bag 22. Filter bag 22 is positioned in connecting region 17 such that at least a region with an increased outer diameter is arranged above perforated filter plate 16. Filter bag 22 is preferably positioned in connecting region 17 such that perforated filter plate 16 lies between the two insertion bands 26 and 28 of filter bag 22. A region with increased outer diameter is thus arranged above perforated filter plate 16 and a further region with increased outer diameter is arranged below perforated filter plate 16. Clip ends 14 of spring clips 12 engage around upper insertion band 28 of filter bag 22. FIG. 6d shows a ready assembled fastening system 1. Insertion bands 26 and 28 and snap ring 32 at upper end 24 of filter bag 22 form a sealing face 46 at cutout 19 of perforated filter plate 16. In addition, filter basket 2 can stabilise the connection of filter bag 22 by means of spring clips 12 and their clip ends 14.

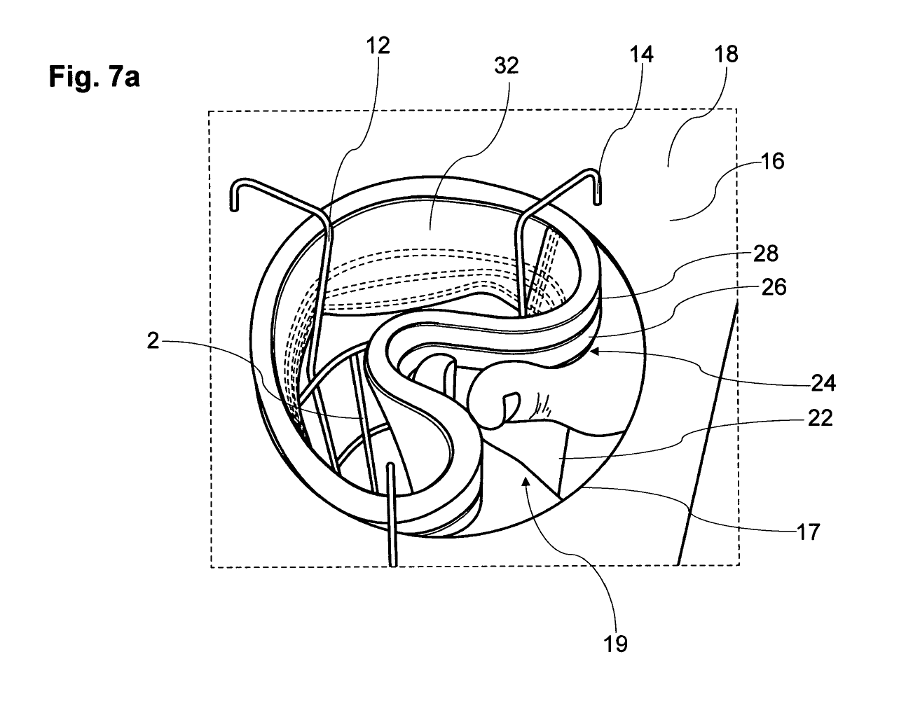

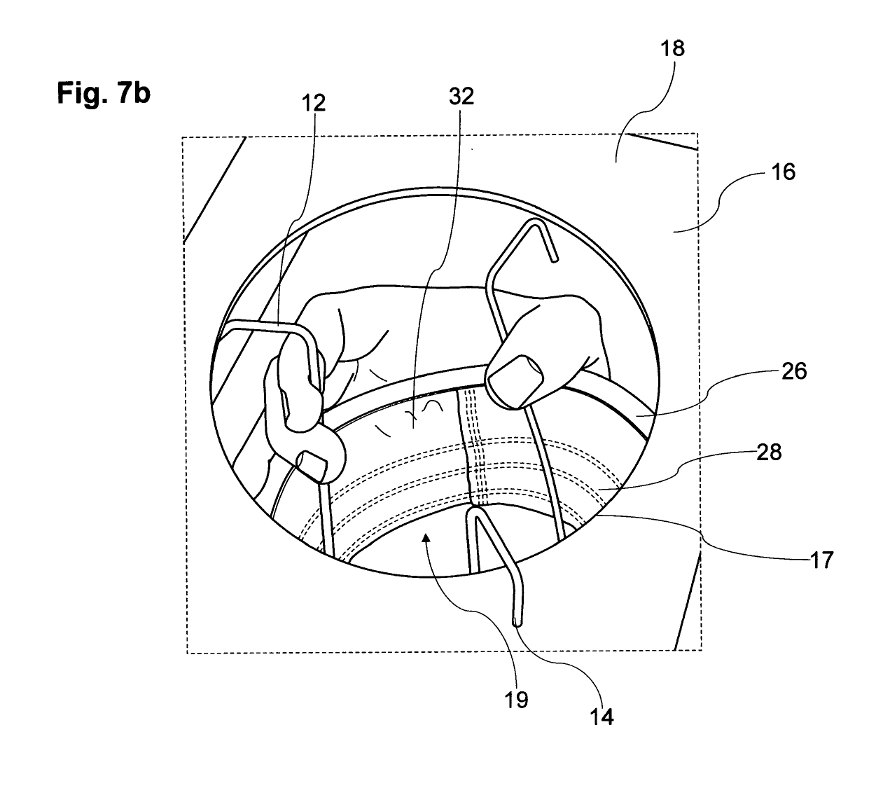

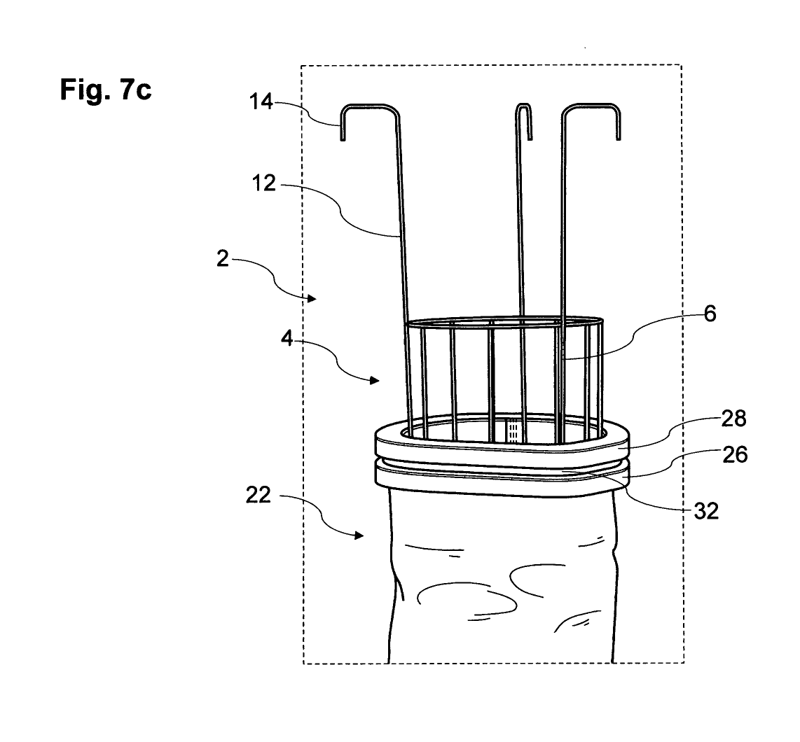

FIGS. 7a to 7c describe three dismantling steps for dismantling fastening system 1. FIG. 7a demonstrates a first dismantling step. Filter bag 22, in the region of snap ring 32, wherein in the region of snap ring 32 according to the present embodiment two insertion bands 26 and 28 are worked into filter bag 22, is deformed in such a way that its cross-section is smaller than the area of the inner cross-section of cutout 19 of connecting region 17. Filter bag 22 can thus be separated from connecting region 17. On account of the distribution of spring clips 12 on filter basket 2, easy access can be gained to upper end 24 of filter bag 22. Spring clips 12 of filter basket 2 can also be easily deformed. In the second dismantling step, illustrated in FIG. 7b, a pressing force directed inwards is exerted against spring clips 12, so that the latter can be guided out of connecting region 17. The filter basket is located roughly at the height of wire mesh 6 of filter basket 2. In the third assembly step, illustrated in FIG. 7c, filter basket 2 is already detached from perforated filter plate 16, and filter bag 22 can be pulled from filter basket 2.

Identical reference numbers are used for identical or identically acting elements of the invention. Furthermore, for the sake of clarity, only reference numbers that are required for the description of the given figure are represented in the individual figures. The represented embodiments only represent examples as to how the device or the method according to the invention can be constituted and do not represent a conclusive limitation.

The invention has been described by reference to a preferred embodiment. A person skilled in the art can however imagine that modifications or changes to the invention can be made without thereby departing from the scope of protection of the following claims.

1. A fastening system comprising
a filter bag with a first outer diameter for filtering dust particles;
a filter basket for the internal stabilization and fastening of the filter bag; and
a connecting region arranged on a perforated filter plate for connecting the filter bag to a filter installation;
wherein the connecting region includes a cutout for the filter bag;
wherein, for the connection to the connecting region, the filter bag includes at one end at least one snap ring;
wherein the filter bag in the region of the snap ring has a second outer diameter, which is at least slightly larger than the first outer diameter of the filter bag;
wherein the filter basket is constituted by a basket-like structure, which includes at its upper end at least two spring elements for connection to the connecting region;
wherein the snap ring is elastically deformable and can be brought into at least a first shape, the cross-sectional area whereof is smaller than an area of the inner cross-section of the cutout of the perforated filter plate.

2. The fastening system according to claim 1, wherein the filter bag also includes two insertion bands spaced apart from one another for the connection to the connecting region.

3. The fastening system according to claim 2, wherein the two insertion bands spaced apart from one another cover the at least one snap ring at least partially over the surface at a side edge.

4. The fastening system according to claim 2, wherein the filter bag is connected to the connecting region in such a way that the two insertion bands lie respectively at the surface and the underside of the perforated filter plate.

5. The fastening system according to claim 2, wherein the two insertion bands lie on the connecting region in such a way that the filter bag cannot perform a vertical movement.

6. The fastening system according to claim 1, wherein the spring elements are spring clips and wherein the filter basket includes at its the upper end two to six, in particular three, spring clips.

7. The fastening system according to claim 1, wherein at least one further snap ring is fitted to the filter bag.

8. The fastening system according to claim 1, wherein a Venturi element is fitted to the connecting region in such a way that securing and/or centring of the filter basket takes place.

9. The fastening system according to claim 8, wherein the Venturi element is fastened to the connecting region via a collar integrally formed on a plate portion.

10. The fastening system according to claim 1, wherein, for the fitting and/or removal of the filter bag and/or of the filter basket, a pressing movement directed approximately in the direction of the centre-point of the snap ring and/or of the spring elements takes place against the snap ring and/or the spring elements.

11. A method for assembling a fastening system according to claim 1,
wherein the spring elements of the filter basket are subjected to pressing inwards and passed through the cutout of the connecting region and suspended in the connecting region;
wherein the filter bag is subjected to pressing inwards in the region of the snap ring and passed through the cutout of the connecting region;
wherein the pressing is then removed from the snap ring, so that the filter bag lies adjacent to the connecting region.

12. The method for dismantling a fastening system according to claim 11,
wherein the filter bag in the region of the snap ring is subjected to pressing inwards and is passed through the cutout of the connecting region out of the latter; and
wherein the spring elements of the filter basket are subjected to pressing inwards and passed through the cutout of the connecting region out of the latter.

13. A fastening system comprising
a filter bag with a first outer diameter for filtering dust particles;
a filter basket for the internal stabilization and fastening of the filter bag; and
a connecting region arranged on a perforated filter plate for connecting the filter basket to a filter installation;
wherein the connecting region includes a cutout for the filter bag;
wherein, for the connection to the connecting region, the filter bag includes at one end at least one snap ring;
wherein the filter bag in the region of the snap ring has a second outer diameter, which is at least slightly larger than the first outer diameter of the filter bag;
wherein the filter basket is constituted by a basket-like structure, which includes at its upper end at least two spring elements for connection to the connecting region;
wherein the snap ring is elastically deformable and can be brought into at least a first shape, the cross-sectional area whereof is smaller than an area of the inner cross-section of the cutout of the perforated filter plate.
